(19) United States
(12) Patent Application Publication
(10) Pub. No.: US 2009/0125470 A1
(43) Pub. Date: May 14, 2009

(54) System and Method for Managing Access Control Lists

(75) Inventors: Sandip Shah, Milpitas, CA (US); Sandeep Bajaj, Fremont, CA (US)

Correspondence Address: AKIN GUMP STRAUSS HAUER & FELD LLP, P.O.BOX 688, DALLAS, TX, 75313-0688, US

(73) Assignee: Juniper Networks, Inc.

(21) Appl. No.: 11/938,060

(22) Filed: Nov. 9, 2007

(51) Int. Cl. G06F 17/00; G06F 21/00; G06N 5/00

(52) U.S. Cl. 706/47; 726/1

(57) ABSTRACT

Systems and methods consistent with the present invention provide better scheme for updating access control list (ACL) rule entries in a ternary content addressable memory (TCAM). In a firewall, ACL rules are scanned for each packet arriving in a router or switch to determine if a match exists between the packet and any of the patterns. Depending on the pattern matched, the corresponding action may be either to accept or to deny the packet. These rules are stored in a TCAM, and new or updated rules may be added to the TCAM. Systems and methods consistent with the present invention determine whether the new or updated rule has a dependency conflict with existing rules in the TCAM. If not, the rule can be inserted anywhere in the TCAM. Accordingly, the TCAM associated with a firewall's ACL can be updated more quickly and efficiently.

### FIELD OF THE INVENTION

The present invention generally relates to network routing, and relates more particularly to managing and updating access control lists in a firewall.

### BACKGROUND

Network elements such as routers or switches typically utilize access control lists (ACLs) to implement packet filtering or other similar functions. A given ACL generally comprises a set of rules, with each rule having one or more fields and a corresponding action. The fields of the rule define a particular pattern that may be associated with a packet, such as particular source and destination addresses in the packet filtering context, with the corresponding action specifying an action that is taken if a packet matches the particular pattern. Generally, the ACL rules are scanned for each packet arriving in a router or switch to determine if a match exists between the packet and any of the patterns. Depending on the pattern matched, the corresponding action may be either to accept or to deny the packet. ACLs typically imply an ordered matching, that is, an ordered list of the rules is utilized, and the first rule in the ordered list of rules having a pattern which matches the packet is applied to that packet.

A ternary content addressable memory (TCAM) is a specialized storage device that may be used to store binary representations of ACL rules (i.e., individual statements within an ACL that specify packet header field values, including wildcards, that a user has associated with a given packet disposition) in respective TCAM entries, and that includes circuitry to compare the supplied search key to all the TCAM entries in parallel, thus effecting an ACL search in which the matching TCAM entries or “hits” correspond to respective ACL rules that are satisfied by the packet being processed.

FIG. 1 illustrates two exemplary TCAMs consistent with methods and systems consistent with the present invention. TCAM 110 contains rules 1, 2 and 3 and empty entries 111 and 112. Note all the empty entries are clustered together at the bottom of the TCAM, since rules are inserted top-down. Thus, if a new rule 4 should be inserted between rules 1 and 2, rules 2 and 3 would have to be moved down to make room. This process is inefficient. In TCAM 120, empty entries 121 and 122 exist between rules X and Y, and Y and Z, respectively. Thus, if new rule Q could be inserted at empty entry 122 without moving any entries. This process is much more efficient. However, inserting rule Q at empty entry 122 may disturb the order dependency in TCAM 120. A more efficient method for maintaining order dependency is desired.

### SUMMARY

Systems and methods consistent with the present invention provide better scheme for updating ACL rule entries in a TCAM. Unlike prior methods, TCAM entry order is only maintained when rules are order dependent. By assigning equivalence class id's to rules, order independent rules are easily and efficiently identified, and thus are inserted in the TCAM wherever there is room. This scheme allows flexibility in updating the TCAM without introducing unnecessary overheard to preserve rule order for order independent rules. Rules are first determined whether they are order dependent on one another. Based on that dependency, equivalence class id's assigned, which are used to quickly determine whether or a new rule is order dependent on an existing rule.

Systems and methods consistent with the present invention are directed to a method for managing an access control list (ACL) stored in a content addressable memory (CAM) having a plurality of rule entries in a data processing system. In one embodiment, a method consistent with systems and methods consistent with the present invention includes receiving a request to add a new rule entry to the CAM, assigning the new rule entry an equivalence class id, adding the rule entry to the CAM independent of rule order when the new rule entry's equivalence class id is different from equivalence class id's of the plurality of rule entries, and adding the rule entry to the CAM while maintaining rule order when the new rule entry's equivalence class id is the same as an equivalence class id of at least on of the plurality of rule entries. In one embodiment consistent with systems and methods consistent with the present invention, assigning the new rule entry an equivalence class id includes determining whether the new rule is order dependent on another rule in the plurality of rules, assigning the new rule and the other rule the same equivalence class id when they are order dependent, and assigning the new rule a distinct equivalence class id when the new rule is order independent of the plurality of rules. In another embodiment consistent with systems and methods consistent with the present invention determining whether the new rule is order dependent on another rule in the plurality of rules includes comparing match types and match type values of the new rule and the other rule, determining the new rule to be order independent of the other rule when they share the same match types and have different match type values, determining the new rule to be order dependent on the other rule when they share the same match types and have at least one match type value in common, determining the new rule to be order dependent on the other rule when they have different match types. Comparing match types may include comparing one of protocol, IP address, and port.

In another embodiment consistent with systems and methods consistent with the present invention, adding the rule entry to the CAM independent of rule order includes adding the rule entry to the first open entry in the CAM and also moving existing rule entries to make room for the new rule entry. A rule may include an action and a packet characteristic, wherein the action is one of permit and deny. The CAM may be a ternary CAM (TCAM), and the method may be performed in a router.

Yet another embodiment consistent with systems and methods consistent with the present invention is directed to a computer-readable medium storing computer executable instructions for performing a method of managing an access control list (ACL) stored in a content addressable memory (CAM) having a plurality of rule entries. In one embodiment, the method comprises the steps of receiving a request to add a new rule entry to the CAM, assigning the new rule entry an equivalence class id, adding the rule entry to the CAM independent of rule order when the new rule entry's equivalence class id is different from equivalence class id's of the plurality of rule entries, and adding the rule entry to the CAM while maintaining rule order when the new rule entry's equivalence class id is the same as an equivalence class id of at least on of the plurality of rule entries. In one embodiment consistent with systems and methods consistent with the present invention, assigning the new rule entry an equivalence class id includes determining whether the new rule is order dependent on another rule in the plurality of rules, assigning the new rule and the other rule the same equivalence class id when they are order dependent, and assigning the new rule a distinct equivalence class id when the new rule is order independent of the plurality of rules. In another embodiment consistent with systems and methods consistent with the present invention determining whether the new rule is order dependent on another rule in the plurality of rules includes comparing match types and match type values of the new rule and the other rule, determining the new rule to be order independent of the other rule when they share the same match types and have different match type values, determining the new rule to be order dependent on the other rule when they share the same match types and have at least one match type value in common, determining the new rule to be order dependent on the other rule when they have different match types. Comparing match types may include comparing one of protocol, IP address, and port.

In another embodiment consistent with systems and methods consistent with the present invention, adding the rule entry to the CAM independent of rule order includes adding the rule entry to the first open entry in the CAM and also moving existing rule entries to make room for the new rule entry. A rule may include an action and a packet characteristic, wherein the action is one of permit and deny. The CAM may be a ternary CAM (TCAM), and the method may be performed in a router.

Yet another embodiment consistent with systems and methods consistent with the present invention is directed to a router comprising a memory including a program for receiving request to add a new rule entry to the CAM, assigning the new rule entry an equivalence class id, adding the rule entry to the CAM independent of rule order when the new rule entry's equivalence class id is different from equivalence class id's of the plurality of rule entries, and adding the rule entry to the CAM while maintaining rule order when the new rule entry's equivalence class id is the same as an equivalence class id of at least on of the plurality of rule entries, and a processor executing the program.

Other systems, methods, features, and advantages consistent with the present invention will become apparent to one with skill in the art upon examination of the following figures and detailed description. It is intended that such additional systems, methods, features, and advantages be included within this description and be within the scope of the invention.

### BRIEF DESCRIPTION OF THE DRAWINGS

The accompanying drawings, which are incorporated in and constitute a part of this specification, illustrate an implementation of methods and systems consistent with the present invention and, together with the description, serve to explain advantages and principles consistent with the invention. In the drawings,

FIG. 1 illustrates exemplary TCAMs consistent with methods and systems consistent with the present invention;

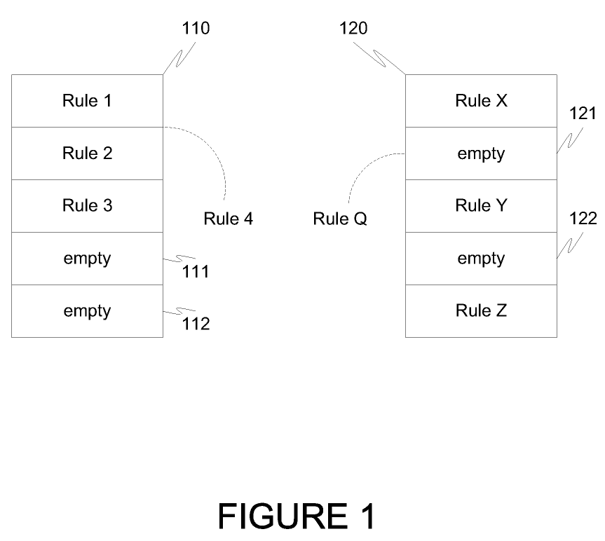

FIG. 2 illustrates an exemplary router in which methods and systems consistent with the present invention may be implemented;

FIG. 3 illustrates a firewall processor consistent with methods and systems consistent with the present invention;

FIG. 4 illustrates an exemplary ACL consistent with methods and systems consistent with the present invention;

FIG. 5 illustrates a rule dependency determination method consistent with methods and systems consistent with the present invention;

FIG. 6 illustrates an equivalence class assignment method consistent with methods and systems consistent with the present invention; and

FIG. 7 illustrates method for adding a new rule to a TCAM consistent with methods and systems consistent with the present invention.

### DETAILED DESCRIPTION

Methods and systems consistent with the present invention provide schemes for assigning equivalence classes based on dependencies that allow faster and more efficient updating of the TCAM entries for an ACL. The rules which are order dependent are assigned the same equivalence class identifier (id). The rules which are order independent are assigned different equivalence class ids. For example, Rule 1 has equivalence class of X and Rule 2 has equivalence class of Y. If Rule 3 is order dependent on Rule 1 and Rule 2, all three rules get equivalence class of Z. When adding a new rule to an open TCAM entry, the equivalence class of the new rule is compared to the other rules in the TCAM. If the equivalence class is different from the other existing rules, the new rule is independent and can be placed anywhere in the TCAM. This scheme is thus more efficient than conventional schemes.

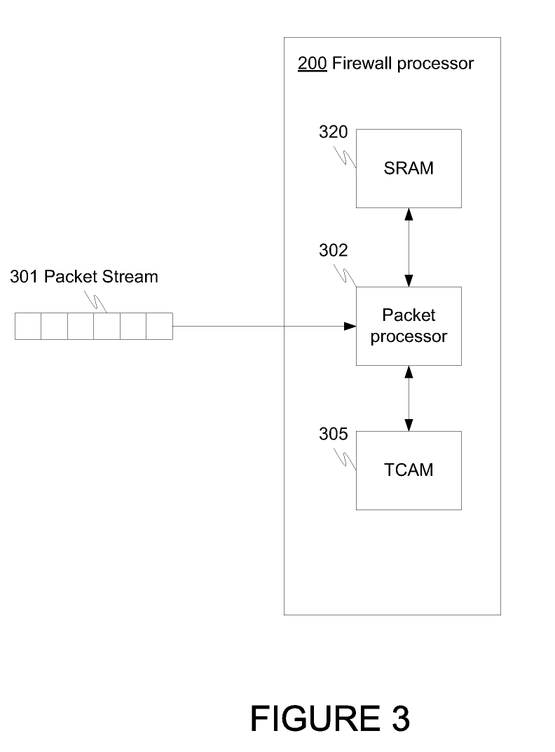

FIG. 3 illustrates an exemplary router 201 consistent with systems and methods consistent with the present invention. Router 201 includes a bus 203 or other communication mechanism for communicating information, and a processor 205 coupled with bus 203 for processing the information. Router 201 also includes a main memory 207, such as a random access memory (RAM) or other dynamic storage device, coupled to bus 203 for storing information and instructions to be executed by processor 205. In addition, main memory 207 may be used for storing temporary variables or other intermediate information during execution of instructions to be executed by processor 205. Main memory 207 includes a program 250 for managing access control lists consistent with methods and systems consistent with the present invention, described below. Router 201 further includes a read only memory (ROM) 209 or other static storage device coupled to bus 203 for storing static information and instructions for processor 205. A storage device 211, such as a magnetic disk or optical disk, is provided and coupled to bus 203 for storing information and instructions.

According to one embodiment, processor 205 executes one or more sequences of one or more instructions contained in main memory 207. Such instructions may be read into main memory 207 from another computer-readable medium, such as storage device 211. Execution of the sequences of instructions in main memory 207 causes processor 205 to perform the process steps described herein. One or more processors in a multi-processing arrangement may also be employed to execute the sequences of instructions contained in main memory 207. In alternative embodiments, hard-wired circuitry may be used in place of or in combination with software instructions. Thus, embodiments are not limited to any specific combination of hardware circuitry and software.

Although described relative to main memory 207 and storage device 211, instructions and other aspects of methods and systems consistent with the present invention may reside on another computer-readable medium, such as a floppy disk, a flexible disk, hard disk, magnetic tape, a CD-ROM, magnetic, optical or physical medium, a RAM, a PROM, and EPROM, a FLASH-EPROM, any other memory chip or cartridge, or any other medium from which a computer can read, either now known or later discovered.

Router 201 also includes a communication interface 219 coupled to bus 203. Communication interface 219 provides a two-way data communication coupling to a network link 221 that is connected to a local network 223. Wireless links may also be implemented. In any such implementation, communication interface 219 sends and receives signals that carry digital data streams representing various types of information.

Router 201 further includes a firewall processor 200 for permitting or denying packets to pass through the router 201, and for performing other security functions. Firewall processor 200 is explained in greater detail below.

Access control lists (ACLs) are classification filters that enable network administrators to control the processing functions applied to incoming packets in packet-switched networks. As the processing functions are typically performed within a network switch, router or other appliance, the functions are generally offered as features of the appliance and thus referred to simply as “features.” ACLs were originally developed to enable administrators to specify packet forwarding rules (permitting packets meeting specified criteria to be forwarded, and denying others), but as the roles of network appliances have expanded to include various security features (e.g., encryption, TCP intercept, multicast flood suppression, VLAN-based, port-based and interface-based filters, ICMP packet suppression, etc.), quality-of-service features (e.g., rate limiting, traffic shaping, policy-based routing), billing features (e.g., accounting of traffic from a set of sources, or to a set of destinations) and so forth, so too has the demand for additional ACLs to specify whether to permit or deny application of such features to a given packet.

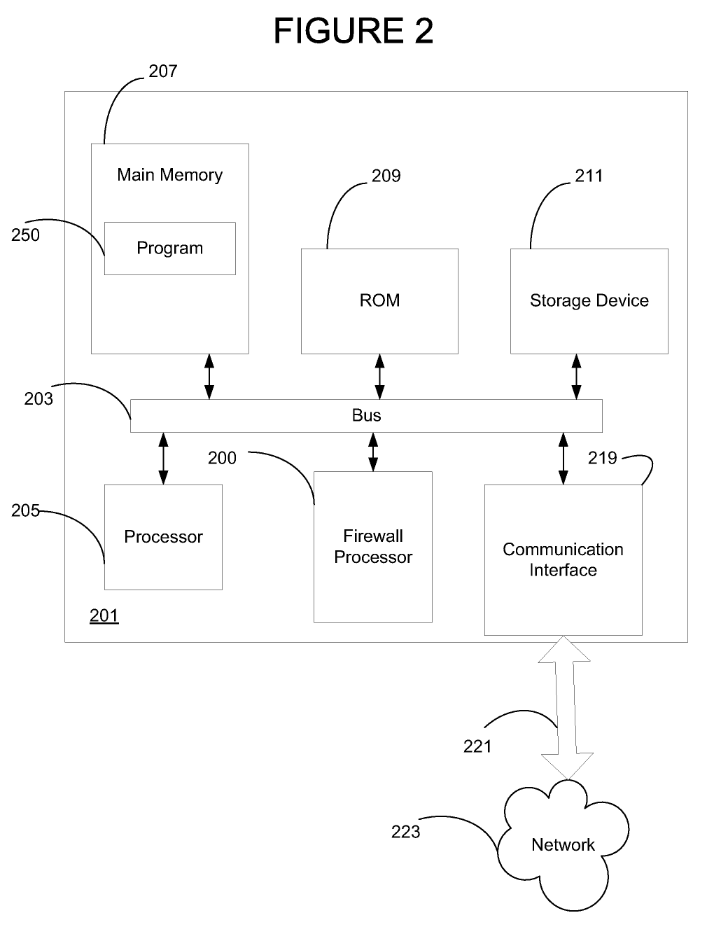

FIG. 2 illustrates a firewall processor 200 that employs ACLs to make packet disposition decisions (e.g., permit or deny application of a given feature to an incoming packet). As shown, a stream of packets 301 is supplied to a packet processor 302. The packet processor 302 constructs a search key from selected fields within the packet header (e.g., source address, destination address, source port, destination port, protocol, etc.) and forwards the search key to a ternary content addressable memory 305 (TCAM). The packet processor 302 applies the TCAM search results to access an action lookup table stored within a static random access memory 320 (SRAM), and thus retrieve an action value that indicates an action to be taken with respect to the packet (e.g., permit or deny application of the feature to which the ACL pertains) and a possible set of ancillary actions (e.g., count occurrence of the ACL-rule match, log an error or other value, save the packet to disk or other storage for later inspection, etc.). When all the action values relating to a given packet have been retrieved, the packet processor 302 may combine the actions according to a programmed algorithm to yield a final packet action and final set of ancillary actions which are applied to permit or deny delivery of the packet to the pertinent feature and carry out the indicated ancillary actions.

As applied to routers, an ACL is implemented as a series of commands that program the router to permit or deny packet access to the routing function. Various classes or families of internetworking devices share common command sets and syntax for ACL programming. The party controlling or maintaining the router (typically, the network administrator) defines the rules by which packet routing is to be controlled. Rule definition is accomplished by commanding the router in accordance with the particular command syntax and programming method appropriate to the type of router used. The router's operational software then translates the access list commands into a form useable by the router.

ACL rules can be simple when expressed in plain English, such as “Permit TCP packets from any source to host with IP address equal to 194.121.68.173 and TCP port number greater than 1023” or complex, such as “Permit UDP packets from any source to host with IP address equal to 142.175.12.40 and TCP port number less than 1023, but not equal to 21, 80, or 128.” In the first example, the corresponding router command, for example, contains a single rule element:
permit tcp any host 194.121.68.173 gt 1023
   where “gt” represents “greater than.” In the latter example, there are four elements to the rule, thus requiring four commands to the router: deny udp any host 142.175.12.40 eq 21 deny udp any host 142.175.12.40 eq 80 deny udp any host 142.175.12.40 eq 128 permit udp any host 142.175.12.40 It 1023

Another common rule example is “Deny TCP traffic going to host with IP address equal to 131.124.87.95 and TCP port number range from 6000 to 6002.” represented in command form as:
deny tep any host 131.124.87.95 range 6000 60002

Rules may also be expressed in terms of permitting or denying access to or from certain destination or source IP addresses (respectively), e.g., “Deny IP traffic coming from subnet 173.201.0.0.” In such situations, the rule command includes the IP address of interest:
deny 173.201.0.0 0.0.255.255

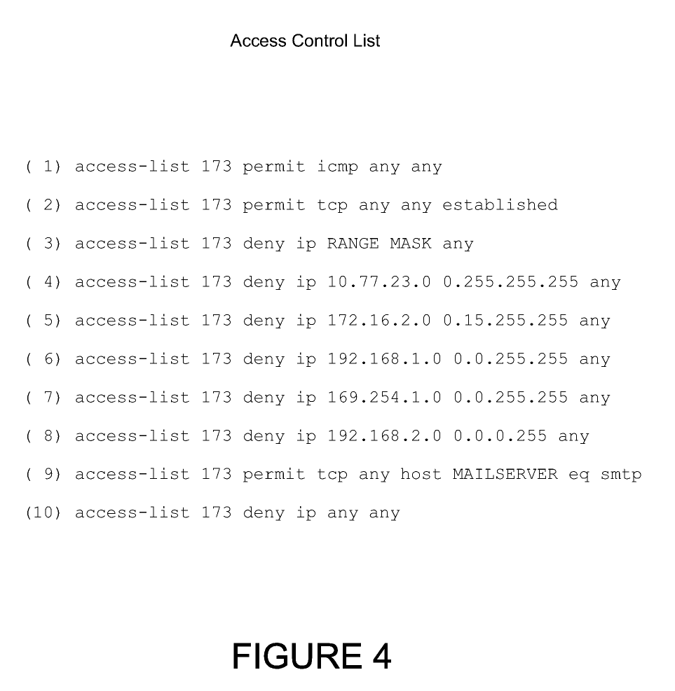

However, rule order can be critical in an ACL. To illustrate this, consider two rules as follows: rule 1 permits packets with characteristic A (source address, for example) and rule 2 denies packets with characteristic B (destination address, for example). A packet with a profile matching both characteristics (from A to B in this case) will match both rules. The rules are dependent. Consequently, the order of rule 1 . . . rule 2 will permit the A to B packet whereas the order rule 2 . . . rule 1 will deny it. An example ACL is illustrated in FIG. 4, where rules 8 and 9 are dependent: an SMTP packet from the 192.168.2.0 network to the mail-server will match both. In its given form, the intention of the ACL policy is that such a packet should be blocked. However, promoting rule 9 above rule 8 would (incorrectly) pass it. Not all rules will be dependent in this way, but those that are must have their relative order in the list preserved if the ACL is to retain its intended purpose. Of course, this only applies for rules of opposite types. Several ‘permit’ rules in a contiguous block, for example, can be freely reordered among themselves.

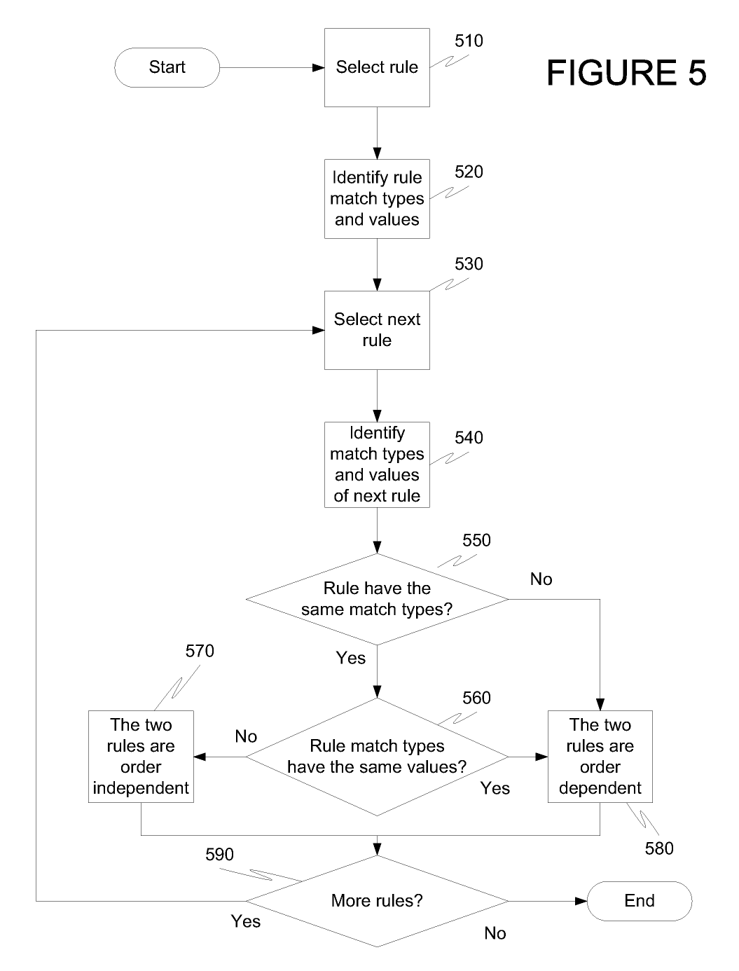

FIG. 5 illustrates a method for determining order dependency consistent with methods and systems consistent with the present invention. A rule is selected, e.g., rule 1, for determining whether other rules in the ACL depend on it (step 510). In selecting the rule, match types and associated values that would be used to filter packets are identified (step 520). Match types are characteristics of packets that are used for comparison to a rule. Packet characteristics include, for example, the protocol, port, originating IP address, destination IP address, etc. For example, a match type may be “protocol” and the value is “TCP.” The rule might also have a match type “port” with a value of “20.” The rule might also have a match type “IP” with a value of “123.45.67.890.” One of ordinary skill in the art will recognized that a match type may be any characteristic associated with the profile of a packet. A second rule, e.g., rule 2, is then selected for comparison to rule 1 (step 530). In selecting that rule, again match types and associated values that would be used to filter packets are identified for that rule (step 540). The match types of rule 1 are then compared to rule 2 (step 550). If rule 1 and rule 2 have at least one of the same match types, the values of each of the match types of rule 1 and rule 2 are compared (step 560). If all of the match types have different values than their corresponding match types in rule 2, rule 1 and rule 2 are determined to be order independent (step 570). If rule 1 and rule 2 have at least one match type not in common, or if at least one match type of rule 1 shares the same value as the corresponding match type in rule 2, rule 1 and rule 2 are determined to be order dependent (step 580). If the there are more rules to compare to rule 1 for order dependency (step 590), then the process is repeated for the next rule at step 510, excluding rules that have already been compared.

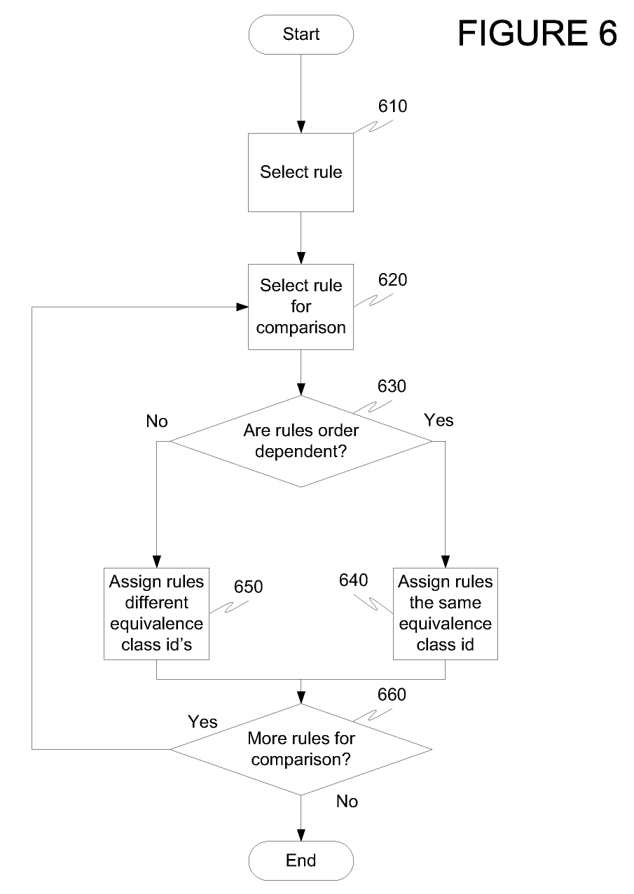

FIG. 6 illustrates a method for assigning equivalence class consistent with methods and systems consistent with the present invention. A rule is selected, e.g. rule 1 (step 610), and a rule for comparison is selected, e.g. rule 2 (step 620). If rule 1 and rule 2 are order dependent (step 630), rule 1 and rule 2 are assigned the same equivalence class, e.g., class Z (step 640). Otherwise, they are assigned different equivalence classes, e.g., rule 1 is assigned class X and rule 2 is assigned class Y (step 650). If the there are more rules to compare to rule 1 for assigning an equivalence class (step 660), then the process is repeated for the next rule at step 620, excluding rules that have already been compared.

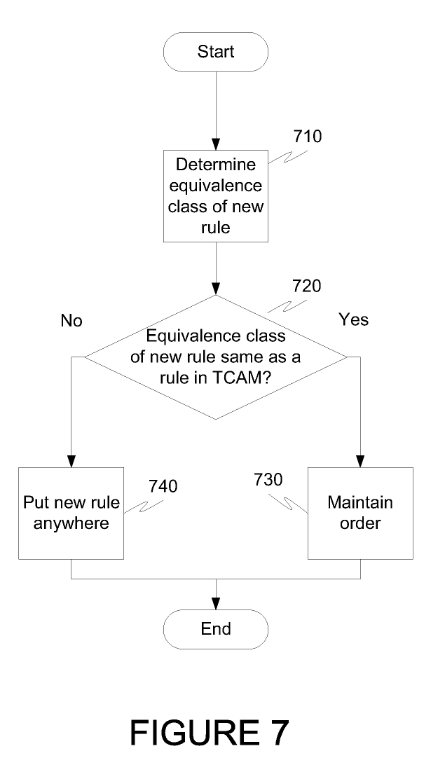

FIG. 7 illustrates a method for adding a new ACL rule to a TCAM entry consistent with methods and systems consistent with the present invention. The equivalence class of the new rule is determined from the process in FIG. 6 (step 710). The equivalence class of the new rule is then compared to the equivalence class of the existing rules in the TCAM (step 720). If the equivalence class of the new rule matches the equivalence class of an existing rule, rule order must be maintained and the rule is placed in an available entry in the TCAM that maintains the relative order of the rules belonging to that equivalence class (step 730). Otherwise, the new rule may be place anywhere in the TCAM, which provides faster and more efficient updating of the TCAM (step 740). Accordingly, rules are efficiently placed in TCAM holes with a fast and efficient scheme for preserving order dependency.

While there has been illustrated and described embodiments consistent with the present invention, it will be understood by those skilled in the art that various changes and modifications may be made and equivalents may be substituted for elements thereof without departing from the true scope of the invention. Therefore, it is intended that this invention not be limited to any particular embodiment disclosed, but that the invention will include all embodiments falling within the scope of the appended claims.

We claim:

1. A method for managing an access control list (ACL) stored in a content addressable memory (CAM) having a plurality of rule entries in a data processing system, the method including the steps of:
receiving a request to add a new rule entry to the CAM;
assigning the new rule entry an equivalence class id;
adding the rule entry to the CAM independent of rule order when the new rule entry's equivalence class id is different from equivalence class id's of the plurality of rule entries; and
adding the rule entry to the CAM while maintaining rule order when the new rule entry's equivalence class id is the same as an equivalence class id of at least on of the plurality of rule entries.

2. The method of claim 1, wherein assigning the new rule entry an equivalence class id includes:
determining whether the new rule is order dependent on another rule in the plurality of rules;
assigning the new rule and the other rule the same equivalence class id when they are order dependent; and
assigning the new rule a distinct equivalence class id when the new rule is order independent of the plurality of rules.

3. The method of claim 2, wherein determining whether the new rule is order dependent on another rule in the plurality of rules includes:
comparing match types and match type values of the new rule and the other rule;
determining the new rule to be order independent of the other rule when they share the same match types and have different match type values;
determining the new rule to be order dependent on the other rule when they share the same match types and have at least one match type value in common; and
determining the new rule to be order dependent on the other rule when they have different match types.

4. The method of claim 3, wherein comparing match types includes comparing one of protocol, IP address, and port.

5. The method of claim 1, wherein adding the rule entry to the CAM independent of rule order includes adding the rule entry to the first open entry in the CAM.

6. The method of claim 1, wherein adding the rule entry to the CAM while maintaining rule order includes moving existing rule entries to make room for the new rule entry.

7. The method of claim 1, wherein a rule includes an action and a packet characteristic.

8. The method of claim 7, the action is one of permit and deny.

9. The method of claim 1, wherein the CAM is a ternary CAM (TCAM).

10. The method of claim 1, wherein the method is performed in a router.

11. A computer-readable medium storing computer executable instructions for performing a method of managing an access control list (ACL) stored in a content addressable memory (CAM) having a plurality of rule entries, the method including the steps of:
receiving request to add a new rule entry to the CAM;
assigning the new rule entry an equivalence class id;
adding the rule entry to the CAM independent of rule order when the new rule entry's equivalence class id is different from equivalence class id's of the plurality of rule entries; and
adding the rule entry to the CAM while maintaining rule order when the new rule entry's equivalence class id is the same as an equivalence class id of at least on of the plurality of rule entries.

12. The computer-readable medium of claim 11, wherein assigning the new rule entry an equivalence class id includes:
determining whether the new rule is order dependent on another rule in the plurality of rules;
assigning the new rule and the other rule the same equivalence class id when they are order dependent; and
assigning the new rule a distinct equivalence class id when the new rule is order independent of the plurality of rules.

13. The computer-readable medium of claim 12, wherein determining whether the new rule is order dependent on another rule in the plurality of rules includes:
comparing match types and match type values of the new rule and the other rule;
determining the new rule to be order independent of the other rule when they share the same match types and have different match type values;
determining the new rule to be order dependent on the other rule when they share the same match types and have at least one match type value in common; and
determining the new rule to be order dependent on the other rule when they have different match types.

14. The computer-readable medium of claim 13, wherein comparing match types includes comparing one of protocol, IP address, and port.

15. The computer-readable medium of claim 11, wherein adding the rule entry to the CAM independent of rule order includes adding the rule entry to the first open entry in the CAM.

16. The computer-readable medium of claim 11, wherein adding the rule entry to the CAM while maintaining rule order includes moving existing rule entries to make room for the new rule entry.

17. The computer-readable medium of claim 11, wherein a rule includes an action and a packet characteristic.

18. The computer-readable medium of claim 17, the action is one of permit and deny.

19. The computer-readable medium of claim 11, wherein the CAM is a TCAM.

20. A router comprising:
a memory including a program for receiving request to add a new rule entry to the CAM, assigning the new rule entry an equivalence class id, adding the rule entry to the CAM independent of rule order when the new rule entry's equivalence class id is different from equivalence class id's of the plurality of rule entries, and adding the rule entry to the CAM while maintaining rule order when the new rule entry's equivalence class id is the same as an equivalence class id of at least on of the plurality of rule entries; and
a processor executing the program.
